(19) United States
(12) Patent Application Publication
(10) Pub. No.: US 2007/0056014 A1
(43) Pub. Date: Mar. 8, 2007

(54) Television receiver and method for single-selection viewing control of the television receiver

(76) Inventor: Zuben Cheng, Xiamen (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/210,225

(22) Filed: Aug. 23, 2005

(51) Int. Cl. H04N 7/16; H04N 7/173

(52) U.S. Cl. 725/134; 725/142; 725/89

(57) ABSTRACT

A television receiver is simply, rapidly and reliably configured for control of television program viewing using a correlated program blocking table containing rating codes associated with at least two rating systems used to rate television programs, the rating codes being arranged in predetermined correlated sets with an index associated with each of the correlated rating code sets. A user interface permits a user to enter an index to configure all rating systems used in a geographical region. Single-selection program screening is therefore supported.

### CROSS-REFERENCE TO RELATED APPLICATIONS

This is the first application filed for the present invention.

### MICROFICHE APPENDIX

Not Applicable.

### TECHNICAL FIELD

This invention relates in general to television and other broadcast systems, and, in particular to a television receiver and a method for single-selection viewing control of the television receiver.

### BACKGROUND OF THE INVENTION

Many systems for providing viewing control, frequently referred to as “parental control”, of television broadcast programming are well known in the art.

As shown in FIG. 1. such systems are generally configured to control display of selected programs on a television 20 using a remote control unit 22 which is used to send control signals directly to television 20 or to a separate controller such as a set top box, video cassette recorder, or tuner 24, for example, all of which are well known in the art. The television signal may be a broadcast signal 21 or a broadband signal 23. The television signals 21,23 are modulated computer readable signals that generally include embedded information, as is well known in the art.

One problem with most viewing control systems is their complexity and the effort required to understand and configure them. Many parents/guardians do not have the knowledge, interest or time to navigate multiple layers of complex menus to properly configure the viewing control system to screen programs rated by a plurality of different rating systems. As is well understood in the art, an effective viewing control system may have to screen programs based on three or more different rating systems. For example, a television receiver located near the United States or Canadian borders may receive programming rated by the Motion Picture Association of America (MPAA ratings); Canadian English Television Ratings (CE-TV); Canadian French Television Ratings (CF-TV); and United States Television Ratings (US-TV). Obviously, configuring a viewing control system to properly screen programs rated by all of these ratings systems is not a trivial task.

There therefore exists a need for a television receiver and a method for single-selection viewing control of the television receiver that permits simple, rapid, accurate, and complete configuration of the receiver.

### SUMMARY OF THE INVENTION

It is therefore an object of the invention to provide a television receiver and a method for single-selection viewing control of the television receiver that permits simple, rapid, accurate and complete configuration of a viewing control system.

In accordance with one aspect of the present invention there is provided a method for single-selection viewing control of a television receiver, comprising: provisioning a memory of the television receiver with a single-selection program blocking table comprising a generic description and an index associated with each of the generic descriptions, the generic descriptions being respectively associated with a correlated set of rating codes of at least two rating systems used to rate television programs; and provisioning the television receiver with an interface that permits a user to input one of the indexes to configure the television receiver to screen television programs rated in accordance with any one of the at least two rating systems.

In accordance with another aspect of the invention there is provided a method for single-selection program viewing control of a television receiver, comprising: provisioning a memory of the television receiver with rating correlation data containing rating codes associated with at least two rating systems used to rate television programs, the rating codes being arranged in predetermined correlated sets with an index associated with each of the correlated rating code sets; and provisioning the television receiver with an interface that permits a user to enter one of the indexes to configure the television receiver to screen television programs rated in accordance with any one of the at least two rating systems.

In accordance with yet another aspect of the invention there is provided a television receiver, comprising: computer readable memory for storing rating correlation data containing rating codes associated with at least two rating systems used to rate television programs, the rating codes being arranged in predetermined correlated sets with an index associated with each of the correlated rating code sets; and computer readable memory for storing computer program code for generating and displaying a user interface that permits a user to input one of the indexes to configure the television receiver to screen television programs rated in accordance with any one of the at least two rating systems.

In accordance with still yet another aspect of the invention there is provided a computer readable modulated signal comprising rating correlation data used to permit a user to configure a television receiver to screen television programs by entering an index to identify a correlated set of rating codes respectively associated with at least two different rating systems used to rate television programs in a geographical area in which the television receiver is used.

In accordance with another aspect of the present invention there is provided a computer readable modulated signal comprising rating system correlation data used to permit a user to configure a television receiver to screen television programs by entering an index to identify a correlated set of rating codes respectively associated with at least two different rating systems used to rate television programs in a geographical area in which the television receiver is used.

### BRIEF DESCRIPTION OF THE DRAWINGS

Further features and advantages of the present invention will become apparent from the following detailed description, taken in combination with the appended drawings, in which:

FIG. 1 is a schematic diagram of a prior art system used to configure program viewing control of a television receiver;

FIG. 2 is a schematic diagram of a portion of display control circuitry used to control the display of television programs using a program viewing control system in accordance with the invention;

FIG. 3 is a schematic diagram of an exemplary program viewing control menu for the system in accordance with the invention;

FIG. 4 is a schematic diagram of a single-selection program blocking display for exercising program viewing control in accordance with the invention;

FIG. 5 is an exemplary implementation of the single-selection program blocking display shown in FIG. 4;

FIG. 6 is an exemplary display of the results of selecting a blocking level that is displayed to a person using single-selection program viewing control in accordance with the invention;

FIG. 7 is an exemplary display of a correlated program blocking table in accordance with the invention to permit fine-tuned control of program viewing in accordance with the invention;

FIG. 8 is a schematic diagram of a display of a screen that permits a user to build a personal correlated program blocking table in accordance with the invention;

FIG. 9 is a schematic diagram of a personal correlated program blocking table constructed by a user of the system in accordance with the invention;

FIG. 10 is a schematic diagram of a display of the correlated program blocking table showing programs to be blocked by the personal correlated program blocking table shown in FIG. 9;

FIG. 11 is a schematic diagram of a screen display that permits a user to select content codes used to further control program viewing using the system in accordance with the invention;

FIG. 12 is a schematic diagram of a screen display that permits a user to further control the viewing of television programs by program category using the system in accordance with the invention;

FIG. 13 is a flow chart illustrating the implementation of the program viewing control menu shown in FIG. 3;

FIG. 14 is a flow chart showing an implementation of the enter/edit master control personal identification number (PIN) function shown as item 1 of the menu shown in FIG. 3;

FIG. 15 is a flow chart showing an implementation of the enter/edit log-in PINs shown as item 2 of the menu shown in FIG. 3;

FIG. 16 is a flow chart showing an implementation of single-selection program blocking shown as item 3 in the menu shown in FIG. 3;

FIG. 17 is a flow chart showing an implementation of a method for building a personal correlated program blocking table shown in FIGS. 7-10;

FIG. 18 is a flow chart showing an implementation of blocking programs by program content codes as shown in FIG. 11;

FIG. 19 is a flow chart showing an implementation of blocking programs by program category codes as shown in FIG. 12; and

FIG. 20 is a flow chart showing an implementation of a correlation information download to a television receiver in accordance with one embodiment of the invention.

It will be noted that throughout the appended drawings, like features are identified by like reference numerals.

### DETAILED DESCRIPTION OF THE PREFERRED EMBODIMENT

The invention provides a television receiver and a method to permit a parent, guardian or other authority to simply, rapidly and reliably configure a viewing control system to consistently screen programs based on selected criteria using rating correlation data provided with or to the system. The rating correlation data includes information about each rating system used in a geographical region, e.g. Motion Picture Association of America (MPAA); United States Television (US-TV); Canadian English (CE-TV) and Canadian French (CF-TV) television rating systems. Rating systems are sometimes referred to in the art as “rating informational schemes”, or simply “informational schemes”. In accordance with the invention, the rating correlation data further includes “rating level descriptors” assigned to each level in a single-selection program blocking table, and a correlated program blocking table storing all of the rating codes in correlated sets respectively identified by an index, as will be explained below in detail.

The rating correlation data may be provided by rating service providers, government agencies, broadcasters or television manufacturers who analyze different rating systems to determine a most appropriate correlation between the various rating systems used to rate programs broadcast to a given geographical region. It is envisioned that the most appropriate correlation will be established as a standard that is universally adopted in each geographic region.

Correlation data may be supplied to a television receiver by any method, including: pre-configuration by the television manufacturer; download from a portable memory device; data imbedded in a broadcast, telecast, satellite, or radio signal; or via a data packet network such as the Internet, all of which are known in the art.

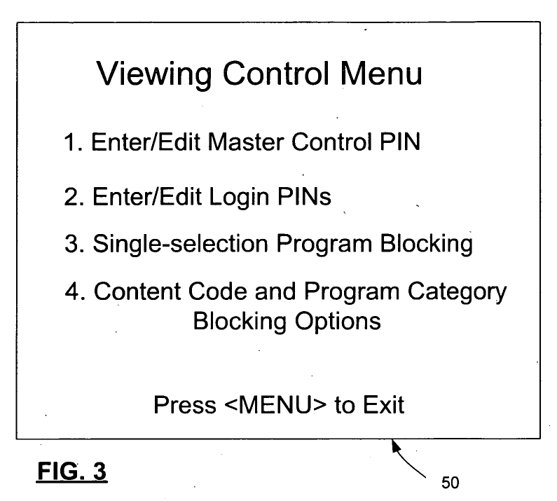

FIG. 2 is a schematic diagram of part of program display control circuitry 30 of a television receiver 20 configured in accordance with the invention. FIG. 2 is not intended to represent all the circuitry required to receive, process and display television signals, as that circuitry is so well known in the art that any person skilled in the art is familiar with each of the components required to receive, process, block and/or display a television signal received via broadcast, satellite transmission, cable, broadband transmission or portable memory. As is well known in the art, the television receiver 20 includes a processor 32 used to process television signals and to control the display thereof. The processor 32 operates using program code stored in non-volatile memory 34, which may include read-only memory (ROM), electronically erasable programmable memory (ERPOM) or any other non-volatile memory known in the art. Stored in non volatile-memory 34 are components of the system in accordance with the invention. Those components include program viewing control logic 38; user preference information 40; single-selection program blocking (SSPB) table 41; correlated program blocking (CPB) table 42; and, content and category blocking tables 4-4, the configuration and use of all of which will be explained below in detail. As is well known in the art, the processor 32 stores data and program information in volatile/cache memory 36 which is used for working storage.

Information in the single-selection program blocking table 41 and the correlated program blocking table 42 may be subject to change for any one of various reasons. For example, a rating system is changed, a new rating system is added, or the like. The single-selection program blocking table 41 and the correlated program blocking table 42, as well as any other program rating information used by the television receiver 20 to extract program rating codes or to screen broadcast programs can be dynamically updated. As explained above, the update information can be received in any one of a number of ways, e.g. embedded in a broadcast signal. When received, the update information is temporarily stored in volatile/cache memory 36, e.g. RAM memory, and subsequently processed and stored in non-volatile memory 34, e.g. EEPROM, all of which is effected using methods known in the art.

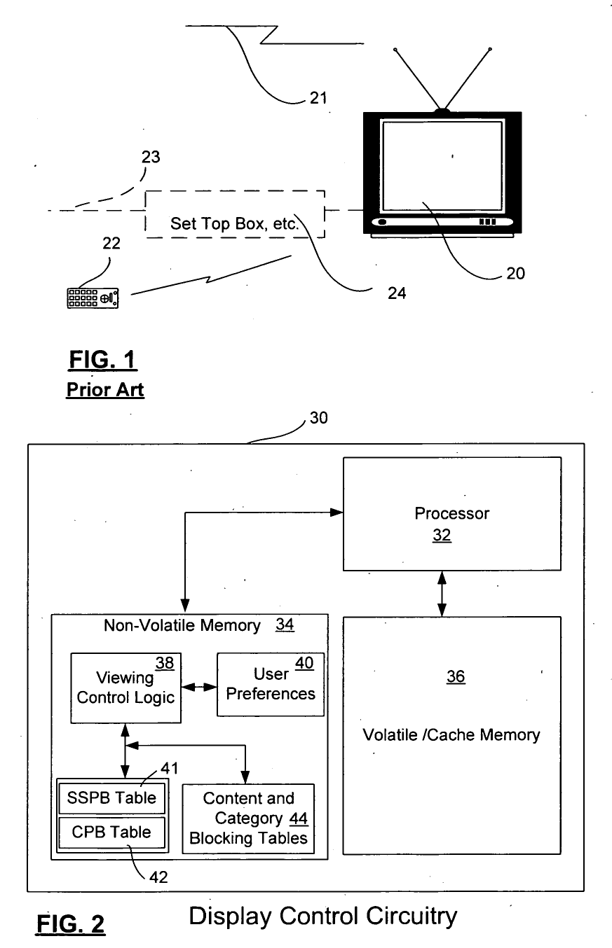

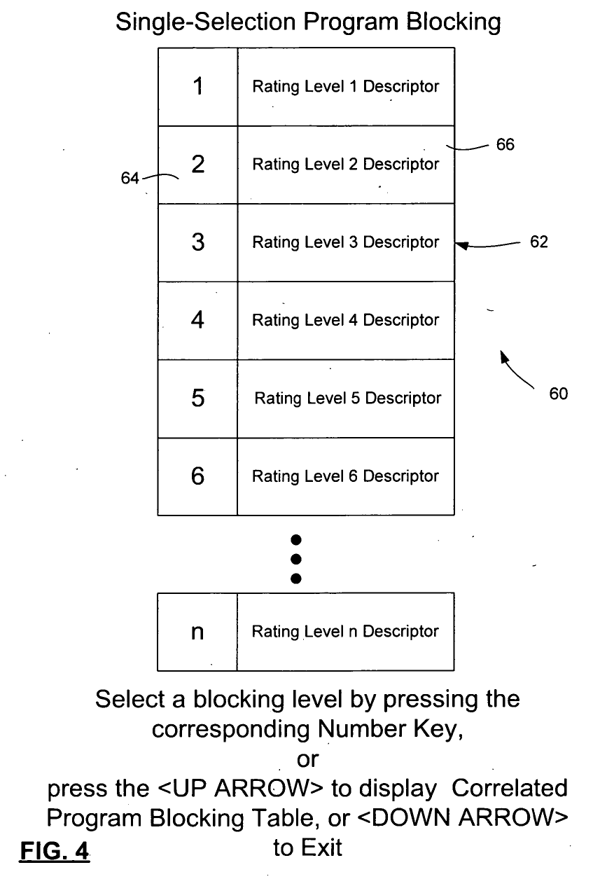

FIG. 3 is a schematic diagram of an exemplary program viewing control menu displayed on a television monitor connected to the television receiver 20 shown in FIG. 1. The program viewing control menu in accordance with this embodiment of the invention provides four options to the user. Namely: 1) Enter/edit master control personal identification number (PIN); 2) Enter/edit log-in PINs; 3) Single-selection program blocking; and 4) Content code and program category blocking options. Each of these functions will be explained below in detail.

FIG. 4 is a schematic diagram of a display screen 60 presented to a user who selects option 3 from the menu shown in FIG. 3. The display screen 60 displays a single-selection program blocking table 62 that includes a first column 64 and a second column 66. The first column 64 displays a plurality of indexes, for a example numbers 1, X . . . xn used to select a corresponding rating level descriptor displayed in column 66. The rating level descriptors are created by one of the authorities noted above to provide a generic description of the program content with which the rating level is associated across each of the correlated rating systems used to rate television programs in the geographical area where the television receiver 20 is being configured to screen programs. In this embodiment of the invention, the user has an option of selecting a blocking level by pressing a corresponding number key on the remote control unit 22 shown in FIG. 1 or pressing the <up arrow> to display a correlated program blocking table or a <down arrow> to exit, as will be explained below in more detail with reference to FIG. 14. As will be understood by those skilled in the art, the input and menu navigation keys described in this document are exemplary only and other keys can be used for the same purpose.

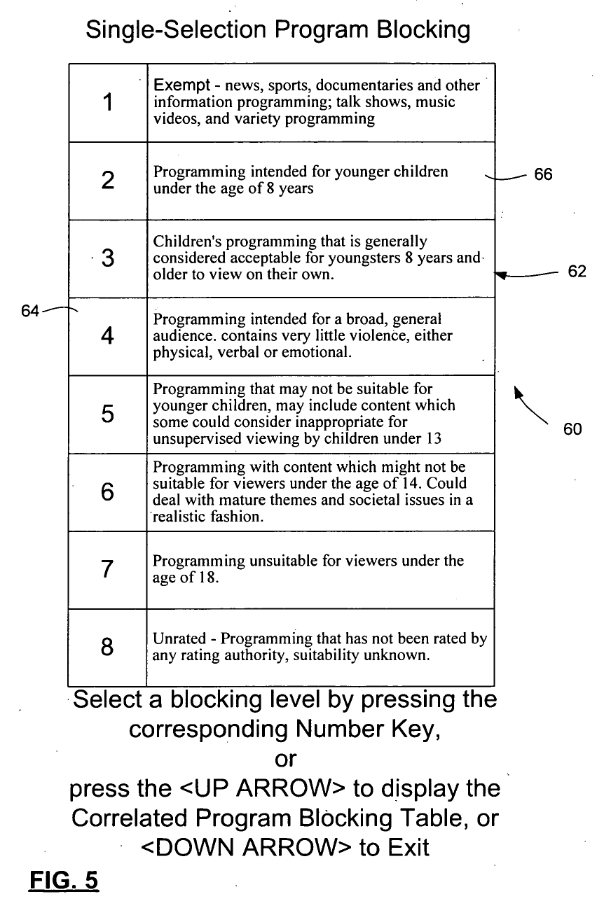

FIG. 5 shows an exemplary implementation of the single-selection program blocking table shown in FIG. 4. In this example, 8 blocking levels are provided. Column 64 therefore contains the numbers 1-8 to permit a user to select one of the blocking levels. Associated with each of the numbers 1-8 is corresponding text tailored to provide a generic description of rating levels provided by various rating systems used to rate programs broadcast to a given geographical region. The text shown in FIG. 5 is exemplary and not intended to represent a system that may be implemented.

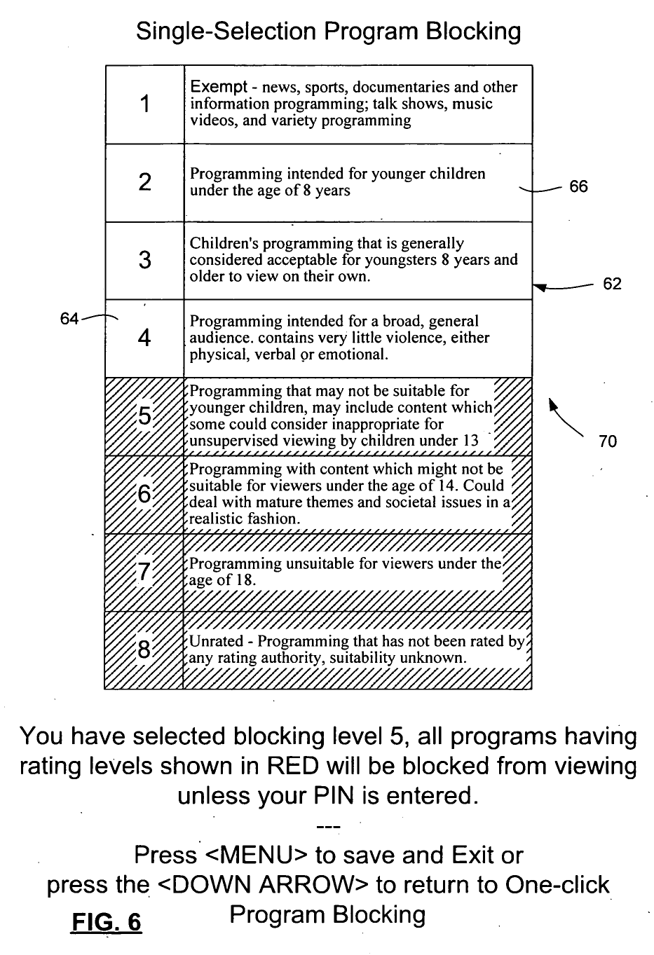

FIG. 6 is an exemplary display 70 that graphically illustrates to the user the results of having selected a blocking level from the display 60 shown in FIG. 5. In this example, the user selected blocking level 5. Consequently, the columns 64, 66 of the single-selection program blocking table 62 beginning with row 5 are displayed in red, or any other desired highlight, to graphically illustrate to the user the effects of the selection. As will be understood by those skilled in the art, once a level is selected, all programs rated at that level or at a higher level are blocked unless a personal identification number (master PIN) is entered to override the program blocking. As shown in FIG. 6 from the display 70 the user is permitted to press the <menu> key to save the selection and exit, or to press the <down arrow> to return to the single-selection program blocking display shown in FIG. 5.

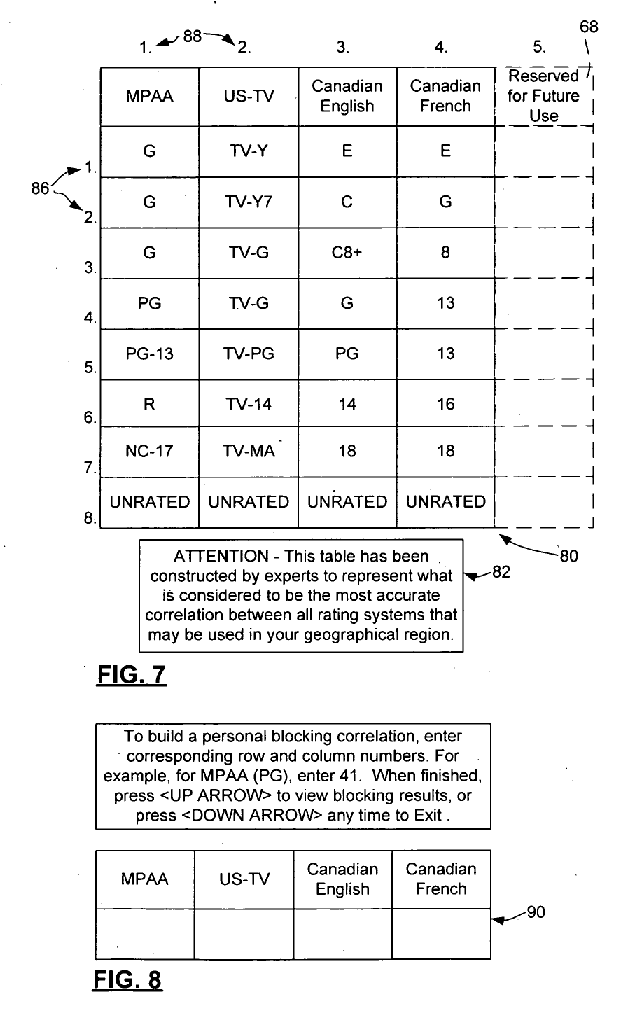

FIG. 7 is a schematic diagram of a display in accordance with the embodiment of the invention shown in FIG. 5 when the user selects the option of displaying the correlated program blocking table 42. In accordance with the invention, users are provided with an option of constructing their own personal correlated program blocking table. In order to simplify this process, only one row of the personal correlated program blocking table needs to be constructed as shown in FIG. 8. This permits sophisticated users to establish their personal preferred correlation between the various rating systems. If the user selects this option from the display 60 shown in FIG. 5 to display the correlated program blocking table by pressing the <up arrow>, the display 80 shown in FIG. 7 is presented. The display 80 may be presented in conjunction with a notice 82 advising that the correlated program blocking table has been constructed by experts to represent what is considered to be the most appropriate correlation between all rating systems that may used in the user's geographical region.

It should be noted that the rating systems shown in FIG. 7, as well as the correlations between the rating systems, are exemplary only and not intended to be optimal, endorsed or implemented in a functional embodiment of the instant invention. As will be noted, an index 86 is associated with each row of the correlated program blocking table shown in FIG. 7. Likewise an index 88 is associated with each column. In one embodiment, the indexes 86, 88 are used to build the personal correlated program blocking table 90, an example of which is shown in FIG. 8. Each row of the correlated program blocking table 80 represents a predetermined set of different rating codes. As will be further noted, the correlated blocking table 80 includes one or more columns 68 reserved for future use. The reserved columns 68 are reserved for any new rating system that may be implemented in the future and supplied to the television receiver by way of download from any one of various media well known in the art. Preferably, unused reserved columns 68 are not displayed to the parent/guardian configuring viewing control.

The personal correlated program blocking table 90 shown in FIG. 8 includes one column for each rating system used in a particular geographical region and one row to accept a respective rating code for each of the respective columns. The user enters their preference for each column using the remote control unit 22 shown in FIG. 1 to key a pair of the indexes 86,88 into each column. The <left arrow> and <right arrow> keys are used to move from column to column in a manner well known in the art.

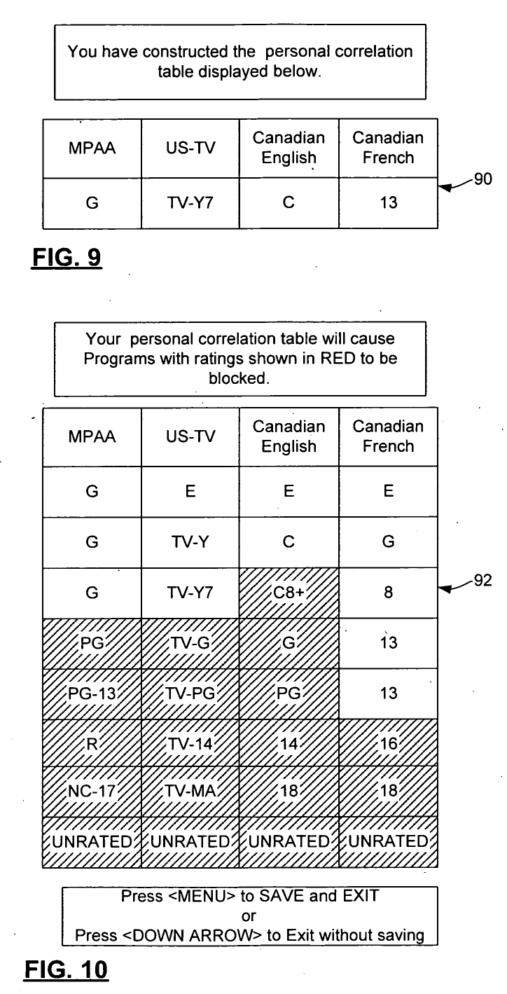

FIG. 9 shows an example of a personal correlated program blocking table 90 created by a user. As will be explained below in more detail, when the user enters the indexes 86,88 such as, for example “1, 1” for the MPAA rating system, the indexes are translated into a corresponding rating code that is displayed in the personal correlated program blocking table 90 shown in FIG. 9. Consequently, the indexes 1, 1 are translated and a (G) that is displayed in the first column of the personal correlated program blocking table 90. Likewise, a 2, 2 entered in column 2 translates into “TV-Y7” that is displayed in column 2, and so on. After the personal correlated program blocking table 90 has been created, the user has the option of pressing the <up arrow> to view the blocking results (see FIG. 8).

A display of the program blocking resulting from the personal correlated program blocking table 90 illustrated in FIG. 9 is shown in FIG. 10. Those programs that will be blocked as a result of the personal correlated program blocking table 90 shown in FIG. 9 are highlighted, to graphically illustrate to the user the results to their selection. After the table 92 is displayed, the user has the option of pressing the <menu> key to save their personal correlated program blocking table 90 and exit or pressing the <down arrow> key to exit without saving the table.

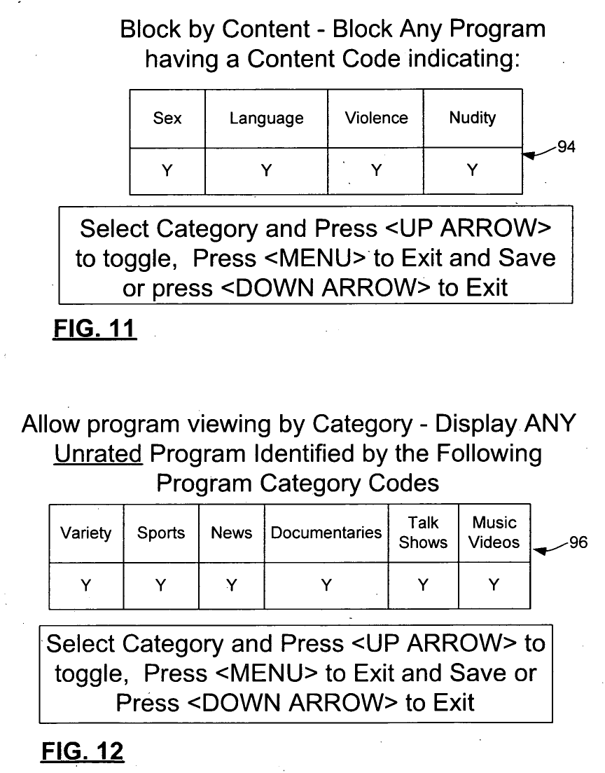

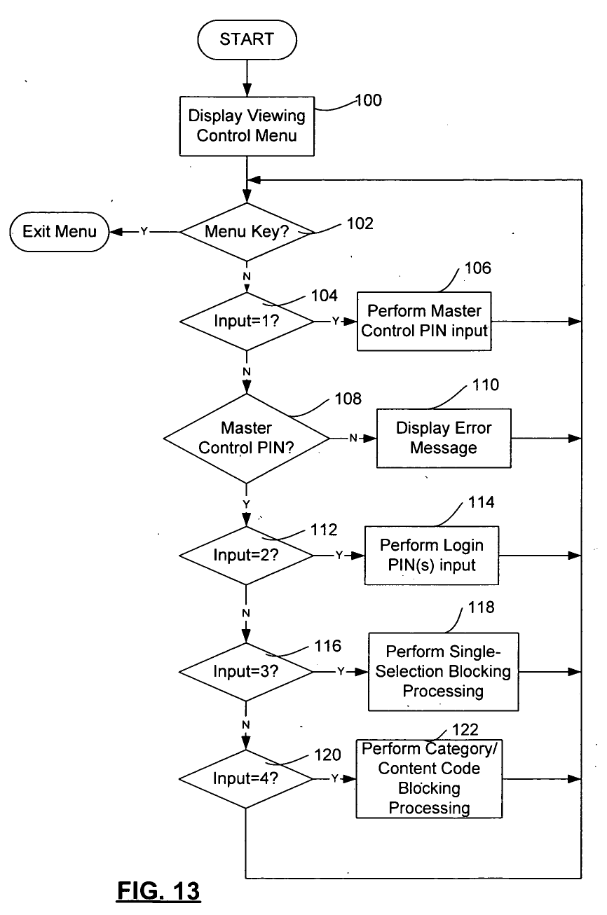

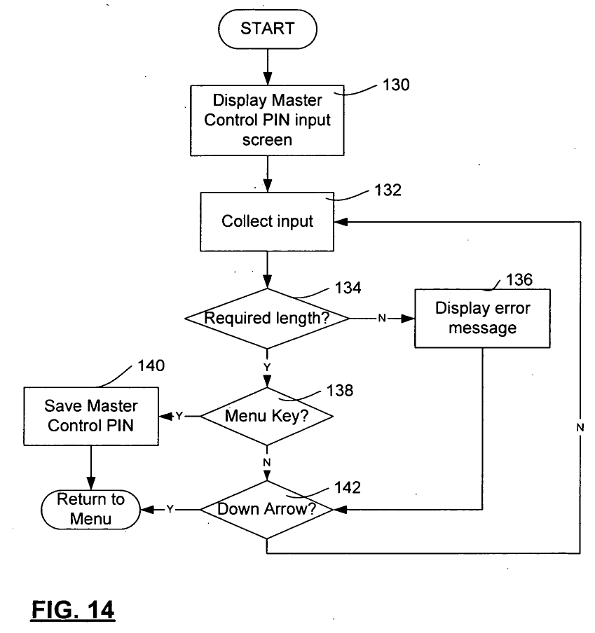

As is well understood in the art, some parents/guardians find that rating systems alone are not adequate to meet their program blocking needs. Consequently, certain rating authorities also provide program content codes that rate programs for content such as sex; foul, crude or abusive language; violence; and/or nudity; etc. In addition, some broadcasters provide codes that identify the types of programs that generally fall into the excluded category, which are normally unrated. In particular, those codes may identify programs in the categories of: varieties; sports; news; documentaries; talk shows; music videos; etc. Consequently, one embodiment of the system in accordance with the invention further provides users with an option of blocking programs by program content code as shown in FIG. 11 and by program category code as shown in FIG. 12. If the user selects option 4 from the menu shown in FIG. 3, the tables 94 and 96 are displayed on the user's television screen. In accordance with one embodiment, by default each program content code is associated with a variable “Y” indicating that program screening will be effected for any program bearing an unblocked rating code if the program is associated with a program content code that indicates that the program contains scenes containing sex, language, violence or nudity. The user can change those options using the <up arrow> to toggle any of the categories from “Y” to “N” indicating that no blocking of programs rated with an unblocked rating code will occur, even if such content codes are associated with the unblocked program.

Program viewing control by category code in accordance with one embodiment of the invention permits the parent/guardian to exercise selective control over the display of programs that are generally unrated, but are classified by a category code. Using this option, the parent/guardian can permit a viewer to display an unrated program if the program signal includes a program category code corresponding to a permitted category. The default program category codes are set to “Y”, indicating that no blocking of any unrated program with one of the program category codes occurs unless the user explicitly changes the default. Once the user has made his selection, in accordance with one embodiment the user can press the <menu> key to exit and save their selections or press the <down arrow> key at any time to exit, as will be explained below in more detail.

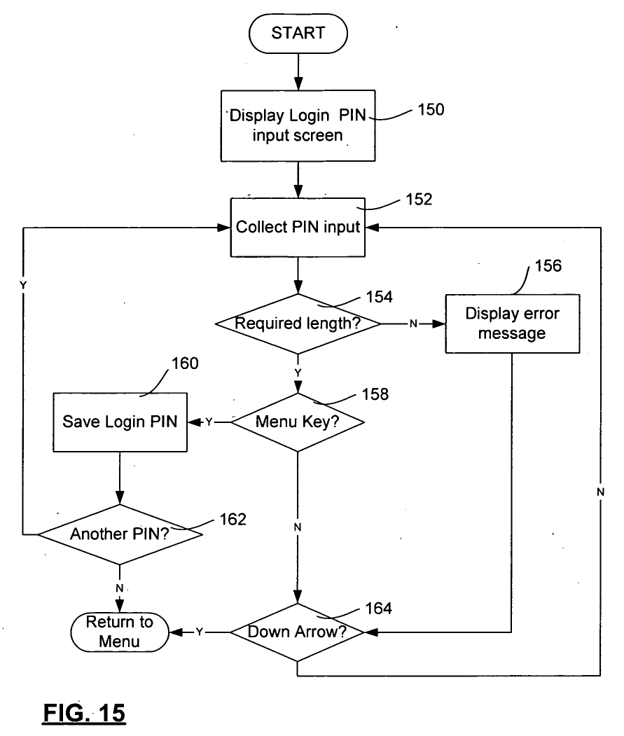

FIG. 13 is a flow chart illustrating an implementation of the viewing control menu shown in FIG. 3. In accordance with this embodiment, the viewing control menu is displayed in step 100 and the system monitors input to determine whether the <menu> key has been pressed (step 102). If so, the system exits the menu and returns to, for example, an initial set up menu (not illustrated). If the input is not the <menu> key, it is determined in step 104 whether the input equals (1) and if so, the program branches to performing master control PIN input (step 106) and then returns to input monitoring. If the input is determined not to be (1) in step 104, the system determines (step 108) whether a master control PIN has been stored in the non-volatile memory 34 (FIG. 2) because none of the remaining functions on the menu can be performed until a master control PIN has been created. Consequently, if the system determines that a master control PIN does not exist, an error message is displayed in step 110 and the system then returns to input monitoring. If the master control PIN exits the system determines whether the input equals “2” (step 112), and if so performs log-in PIN input (step 114). In accordance with the invention, a plurality of log-in PINs can be input if the television receiver 30 supports viewer log-in. This permits a program blocking table to be created for each of a plurality of log-in PINs and the program blocking codes that are used to block programs depend on the log-in PIN, in a manner known in the art. Consequently, all of the functionality described above can be associated with a particular log-in PIN, as will be described in more detail below.

If it is determined in step 112 that the input is not equal to (2), the input is tested to determine whether it equals (3) (step 116). If so, the system performs single-selection program blocking processing (step 118). The system then returns to input monitoring. If not, the input is monitored (step 120) to determine whether it equals “4” and if so, the system performs category/content code blocking processing (step 122) and then returns to input monitoring. If any other key is pressed, that key is ignored.

FIG. 14 is a flow chart illustrating an implementation of master control PIN input. In step 130, a master control PIN input screen (not shown) is displayed. The system then collects input (step 132) and it is determined whether the master control PIN has a required length (step 134). If not, an error message is displayed such as “Master control PIN must be 6 characters or more in length” (step 136). The program then branches to step 142 to determine whether the <down arrow> has been pressed to return to the menu 50 shown in FIG. 3. Otherwise, it is determined in step 138 whether the <menu> key has been pressed, which indicates that the user wishes to save the master control PIN. If so, the master control PIN is saved in step 140 and program returns to the menu. As will be understood by those skilled in the art, the program may further include steps that require the user to re-input the master control PIN for purposes of verification.

FIG. 15 is a flow chart illustrating one implementation of the menu 50 function (2) shown in FIG. 3 for creating log-in personal identification numbers (PINs). In step 150 the system displays a log-in PIN input screen (not shown) and collects user input in step 152. In step 154 it is determined whether the PIN has the required length, as explained above with reference to FIG. 14. If not, an error message is displayed (step 156) and the system determines in step 164 whether the <down arrow> has been pressed. If so, the system returns to the main menu shown in FIG. 3. Otherwise, the system branches back to step 152 to collect user input. If the input PIN has the required length, the system determines in step 158 whether the <menu> key has been selected and if so saves the log-in PIN (step 160). The system then displays an option to input another PIN (step 162) and if that option is selected returns to step 152. Otherwise the system returns to the main menu. As will be understood by those skilled in the art, each log-in PIN may optionally be associated with a user name or other identification and each log-in PIN input may be verified by requiring the user to re-input the same PIN in a manner well known in the art.

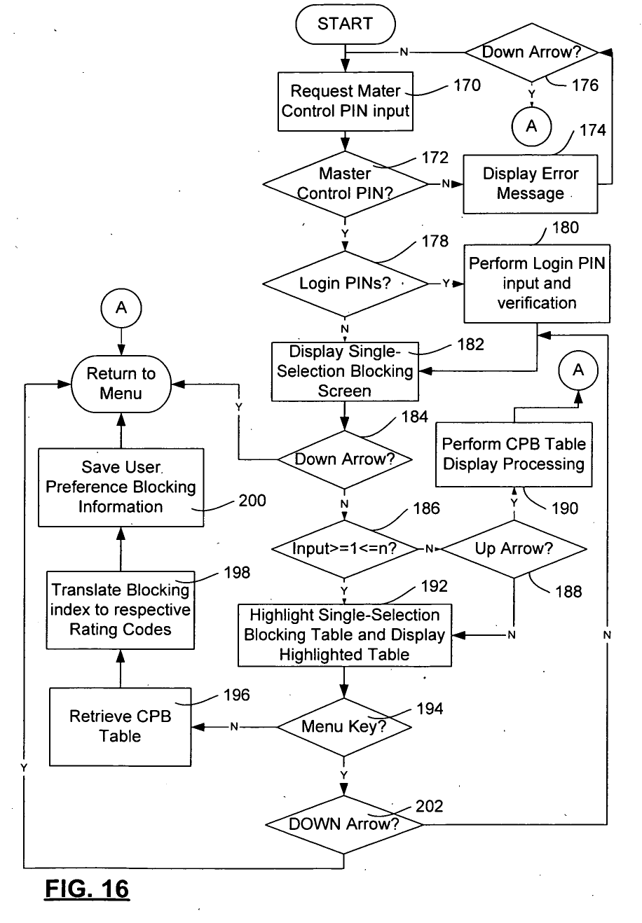

FIG. 16 is a flow chart illustrating the process of single-selection program blocking shown in FIGS. 5 and 6. When the user selects option (3) from the menu 50 shown in FIG. 3, the system requests master control PIN input (step 170) and determines in step 172 whether the input matches the master control PIN stored in the non-volatile memory 34 (FIG. 2). If it does not, an error message is displayed (step 174) and it is determined in step 176 whether the down arrow is selected. If so, the program returns to the display of the menu 50. Otherwise, the program once again request master control PIN input (step 170). As will be understood by those skilled in the art, the number of iterations of this loop may be limited to no more than 3, for example.

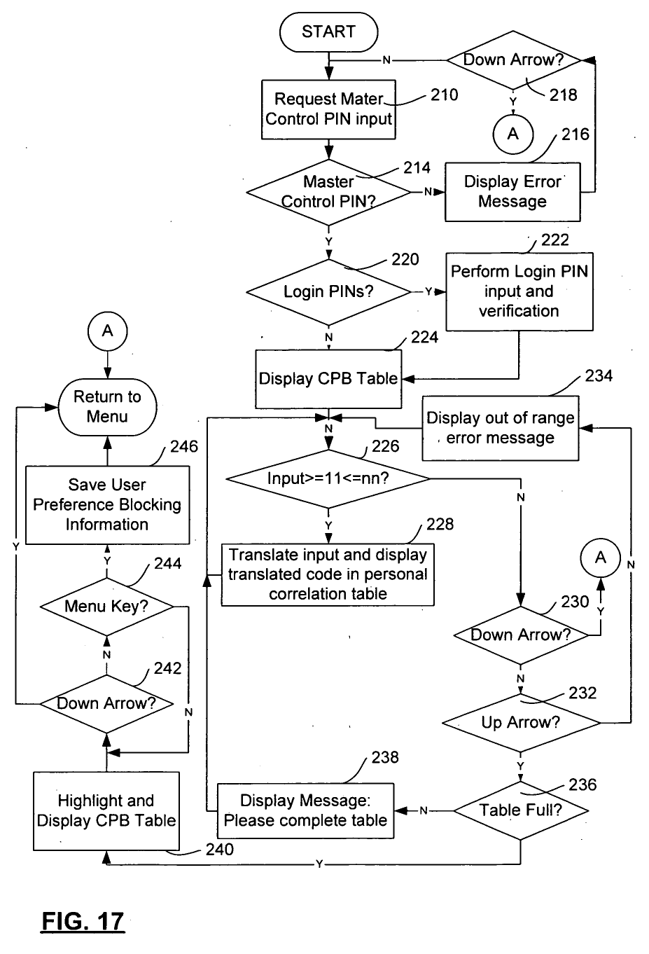

If the master control PIN is correctly input, the program branches to step 178 where the system determines whether any log-in PINs have been stored in the non-volatile memory 34. If so, the system displays an option that permits the user to input a log-in PIN with which the program blocking information is to be associated. If that option is selected, log-in PIN input and verification is performed (step 180) in a manner well known in the art. In either case, the program branches to a display of the single-selection blocking screen shown in FIG. 5 (step 182). The system then monitors for user input. In step 184 it is determined whether the <down arrow> has been selected. If so, the system returns to the menu 50. If not, it is determined in step 186 whether the input is greater than or equal to “1” or less than or equal to “n”, the range of selection that can be made from the single-selection blocking table shown in FIG. 5 (step 186). If the input is not in that range, it is determined in step 188 whether the input equals an <up arrow> (step 188) If so, the program performs correlated program blocking table display processing step 190, which will be explained in more detail with reference to FIG. 17. The program then returns to the main menu. If the input is within the expected range as determined in step 186, the index input by the user is translated into a row of the single-selection blocking table and the blocking table is highlighted and displayed as shown in FIG. 6.

The system then monitors input to determine whether the menu key is selected (step 194). If so, the system retrieves the correlated program blocking table (CPB table 42) from the non-volatile memory 34 (step 196) and translates the blocking index to the respective rating codes (step 198) the system then saves the user preference blocking information (step 200) and returns to the main menu. If it is determined in step 194 that the <menu> key was not selected, the system determines in step 202 whether the <down arrow> was selected. If so, the system returns to the main menu without saving user preference information. Otherwise, the system returns to step 182 and continues to monitor user input.

FIG. 17 is a flow chart illustrating the correlated program blocking table display processing. As explained above with reference to FIGS. 7-10, the system provides a user with an option of creating a personal correlated program blocking table 90 in order to provide the flexibility that sophisticated users may desire. This option may be selected from the display by selecting the <up arrow>. When that selection is made, in this embodiment the system requires re-input of the master control PIN (step 210) and the master control PIN is verified in step 214. If the master control PIN is incorrectly input, an error message is displayed in step 216 and the system monitors input to determine whether the <down arrow> key is selected (step 218) as explained above with reference to FIG. 16. Optionally, the re-input of the master control PIN is not required.

In any event, the system requests whether the personal blocking correlation is to be associated with a log-in PIN (step 220) if so, log-in PIN input and verification is performed (step 222). In either case, the correlated program blocking table (see FIG. 7) is displayed (step 224). The system then monitors input to determine whether the input is greater than or equal to “1,1” and less than or equal to “n,n”, i.e. within the allowed range. If so, the user input is translated and the corresponding rating code is displayed in the proper column of the personal correlated program blocking table 90, as explained above with reference to FIG. 8. The system then returns to monitoring user input.

If the input is not numeric as determined in step 226 or not within range, the system determines in step 230 whether the <down arrow> key was selected. If not, it is determined in step 232 whether the <up arrow> key was selected. If not, the system displays an out of range error message (step 234) and returns to monitoring user input. If the <up arrow> key was selected in step 232, it is determined in step 236 whether the personal correlated program blocking table 90 is full, i.e. whether each column has been assigned a rating code. If not, a message is displayed, such as “Please complete your personal correlated program blocking table” (step 238) and the program returns to monitoring user input in step 226. If the table 90 is determined to be completed in step 236, the system highlights and displays the correlated program blocking table 92 as shown in FIG. 10. The system then monitors user input to determine whether the down arrow is selected (step 242). If so, it returns to, the main menu without saving the personal correlated program blocking table 90. As will be understood by those skilled in the art, the system may ask the user if they wish to exit without saving their changes.

It is then determined in step 244 whether the <menu> key was selected. If not, the system returns to monitoring user input. If so, the system saves the user preference blocking information to the non-volatile memory 34 (step 246) and returns to the menu 50 shown in FIG. 3.

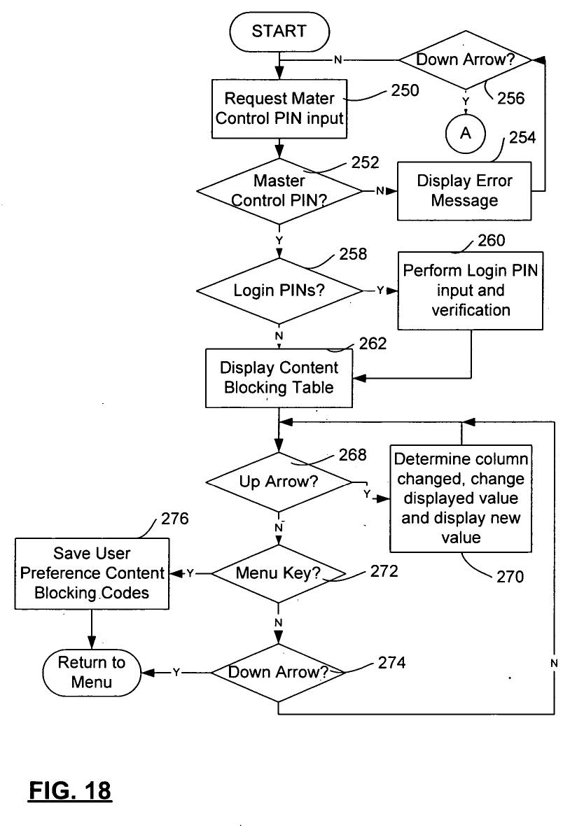

FIG. 18 is a flow chart illustrating one implementation of the invention for performing program blocking by content codes shown in FIG. 11. If item 4 is selected from the main menu shown in FIG. 3, the system requests master control PIN input (step 250) and determines in step 252 whether the input PIN matches the master control PIN stored in the non-volatile memory 34. If there is no match, an error message is displayed (step 254) and it is determined in step 256 whether the <down arrow> key was pressed. If not, another request for the master control PIN is displayed and steps 250 and 252 are repeated. If the master control PIN is correctly input, the user is queried in step 258 to determine whether the content code blocking option is to be associated with a log-in PIN. If so, the system performs log-in PIN input and verification (step 260). In either case, the system displays the content blocking table 94 shown in FIG. 11 (step 262). The system then monitors user input to determine whether the <up arrow> key was pressed. If the user presses the <up arrow> key, the system determines which column in the content blocking table 94 has been changed, changes the displayed value, which may be a change from “Y” to “N”, or vice versa, and displays the new value in the appropriate column (step 270) the system then returns to monitoring user input. If the <up arrow> key was not pressed in step 268, the system determines whether the <menu> key was selected (step 272). If so, the system saves the user preference program content blocking codes in the non-volatile memory 34 (step 276) and returns to the main menu shown in FIG. 3. If the menu key was not selected, the system determines whether the <down arrow> key was pressed (step 274). If so, the system returns to the menu 50. If not, the system returns to monitoring user input.

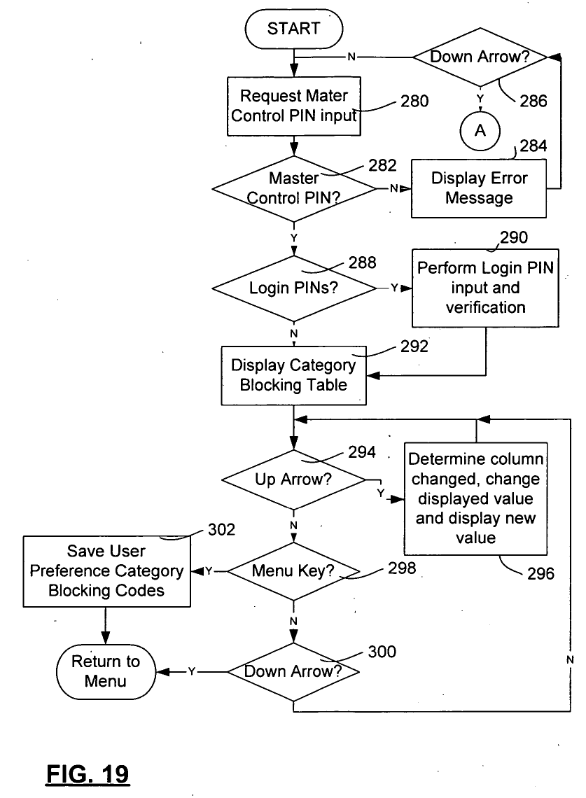

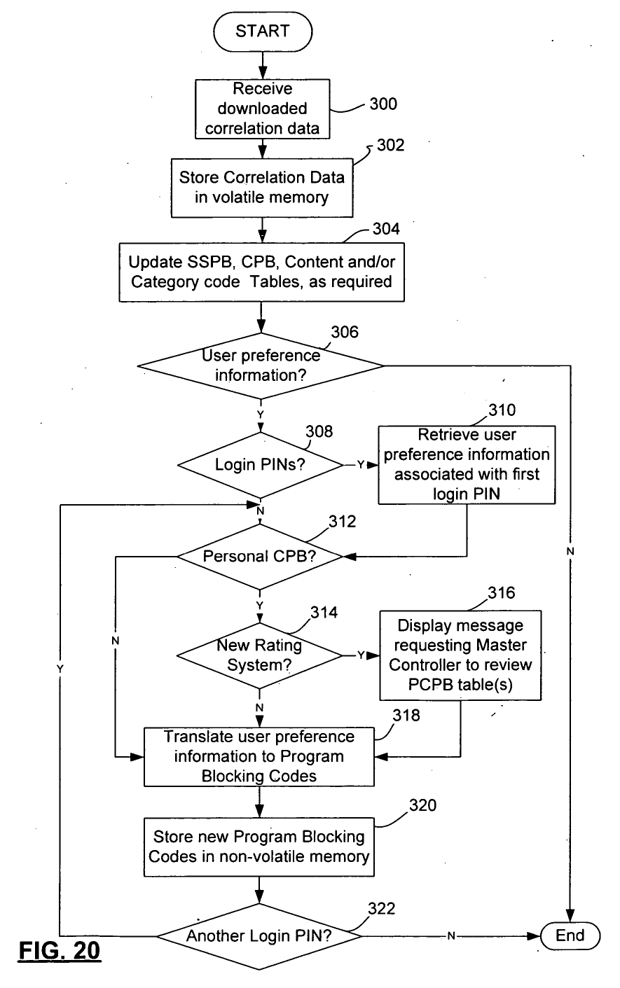

FIG. 19 illustrates an implementation of the system in accordance with the invention when the user elects to allow program display by program category code by using the category code table 96 shown in FIG. 12. When item 4 from the menu 50 shown in FIG. 3 is selected, the system requests and verifies the master control PIN input and determines whether the category codes selected are to be associated with a log-in PIN in the same way as described above with reference to FIG. 18 (steps 280-290). After appropriate verifications are made, the system displays the program category code table 96 shown in FIG. 12 (step 292). The system then monitors user input to determine whether the <up arrow> key has been pressed (step 294). If so, the system determines the column changed and replaces the displayed value with the new value as explained above with reference to FIG. 18 (step 296). If the <up arrow> key was not selected, the system determines in step 298 whether the <menu> key was selected. If the <menu> key was selected, the system saves the user preference program category blocking codes (step 302) and returns to the main menu 50. If the <menu> key was not selected, the system determines whether the <down arrow> key was selected (step 300). If not, the system returns to monitoring user input. If so, the system returns to the main menu 50.

FIG. 20 is a flow chart illustrating one implementation of a method in accordance with the invention for handling downloaded correlation data received by the display control circuitry 30 shown in FIG. 2. In step 300, the downloaded correlation data is received by the display control circuitry 30. The downloaded correlation data may include data for filing or modifying either the single-selection program blocking table 41; the correlated program blocking table 42; or the content and category blocking tables 44 (FIG. 2). The downloaded correlation data may also include information about how and/or where program rating codes are embedded in a program signal, or any other information required to process, decode, or interpret program rating codes, program content codes or program category codes. As explained above, the correlation data may be embedded in a television signal; embedded in a satellite direct broadcast signal; received via a coaxial cable connection; or received from a portable memory device, such as a CD Rom, a memory stick, or the like.

The received correlation data is stored in volatile memory (step 302) such as DRAM. After the received data is stored in volatile memory, the processor 32 examines the received data and determines whether the single-selection program blocking table (SSPB 41), the correlated blocking table (CPB 42), the content code and/or category code tables 44 must be updated in response to the data, and all required updates are effected (step 304). The processor 32 then examines the non-volatile memory 34 to determine whether user preference information 40 has been stored (step 306). If not, no further processing is required and the program ends.

If it is determined in step 306 the user preference information has been stored, the processor 32 determines in step 308 whether log-in PINs have also been stored. If so, the processor 32 retrieves user preference information associated with the first log-in PIN (step 310). The processor 32 then determines whether a personal correlated program blocking table 90 (see FIGS. 8 and 9) has been created (step 312) if not, the processor 32 translates user preference information into program blocking codes associated with the updated table(s) (step 318). The new program blocking codes are then stored in non-volatile memory as user preference information 40 (step 320) and then it is determined in step 322 if another log-in PIN exits. If not, the program ends. Otherwise, the program returns to step 312.

If it is determined in step 312 that a personal correlated program blocking table 90 exits, it is determined in step 314 whether the downloaded correlation data included information associated with a new rating system. In other words, it is determined in step 314 whether a new rating system has been added to the correlated program blocking table 42. If this is the case, the processor 32 generates a message that is displayed requesting the master controller to review all personal correlated program blocking tables (step 316). The processor 32 may be programmed to generate and display this message, for example, each time the television receiver is switched on until menu item (3) is selected from the viewing control menu 50 (see FIG. 3). In any event, the processor 32 then translates the user preference information into program blocking codes by mapping from existing user preference information to the new rating system codes which are arranged in correlated sets with prior existing codes as explained above (step 318). As also explained above, thereafter the processor 32 stores the new program blocking codes in non-volatile memory (step 320) and it is determined in step 322 whether another log-in PIN exits. If not, the program returns to step 312. Otherwise the program ends.

As will be understood by those skilled in the art, the rating codes and the optional content and category codes selected by the user are used by the system in a manner well known in the art to effect program screening. The methods for transmitting such codes and effecting program screening are very well understood.

Likewise, as will be understood by any person skilled in the art, and explained above, methods for downloading or updating program rating codes, program content blocking codes and program category codes are likewise well known to those skilled in the art. The invention applies to any rating system and is adequately flexible to be adapted to use in any geographical region, regardless of the number of rating systems that may be used in that geographical region.

The system provides a simple, quickly configured, reliable program viewing control system that is easily configured by even the least sophisticated of parents/guardians.

The embodiment(s) of the invention described above is(are) intended to be exemplary only. The scope of the invention is therefore intended to be limited solely by the scope of the appended claims.

I/We claim:

1. A method for single-selection viewing control of a television receiver, comprising:
provisioning a memory of the television receiver with a single-selection program blocking table comprising a generic description and an index associated with each of the generic descriptions, the generic descriptions being respectively associated with a correlated set of rating codes of at least two rating systems used to rate television programs; and
provisioning the television receiver with an interface that permits a user to input one of the indexes to configure the television receiver to screen television programs rated in accordance with any one of the at least two rating systems.

2. The method as claimed in claim 1 wherein provisioning the memory comprises any one of:
pre-configuring a read only memory of the television receiver with the rating correlation data;
downloading rating correlation data embedded in a television signal;
downloading rating correlation data embedded in a satellite direct broadcast signal;
downloading rating correlation data from a coaxial cable connection;
downloading rating correlation data in a broadband signal; and
downloading rating correlation data from a portable memory device.

3. The method as clamed in claim 1 wherein provisioning the television receiver with an interface comprises provisioning the television receiver to accept input of a master control personal identification number required to input or change the one of the indexes.

4. The method as claimed in claim 1 wherein provisioning the television receiver with an interface comprises provisioning the television receiver to accept input of one or more log-in personal identification numbers.

5. The method as claimed in claim 4 wherein provisioning the television receiver further comprises provisioning the television receiver to accept input of a one of the indexes for each of the log-in personal identification numbers.

6. The method as clamed in claim 1 wherein provisioning the television receiver with an interface comprises provisioning the television receiver to display the single-selection program blocking table comprising a first column containing the index and a second column containing the generic description of each of the correlated sets of rating codes.

7. The method as claimed in claim 6 further comprising accepting an input of the index from the user, and translating the index using a correlated program blocking table to obtain a plurality of program rating codes to be used to screen television programs.

8. The method as claimed in claim 7 further comprising highlighting a row of the single-selection program blocking table corresponding to the index input by the user, as well as any other rows having a higher index, and displaying the highlighted table to the user to graphically illustrate to the user the program blocking effects of the index input by the user.

9. The method as claimed in claim 6 wherein accepting the user input comprises accepting input of a single character.

10. The method as claimed in claim 1, further comprising providing a user interface to permit the user to construct a personal correlated program blocking table used to select rating codes for screening the television programs.

11. The method as claimed in claim 10 wherein providing the user interface comprises displaying a correlated program blocking table to the user, the correlated program blocking table having an associated row and column index to permit the user to specify rating codes to be placed in the personal correlated program blocking table.

12. The method as claimed in claim 11 wherein providing the user interface comprises:
providing a personal correlated program blocking table comprising a single row and a plurality of columns, one column for each of the at least two rating systems;
permitting the user to input an index for each column in the personal correlated program blocking table; and
translating the index into a rating code that is displayed in a corresponding column of the personal correlated program blocking table.

13. The method as claimed in claim 12 further comprising:
translating the personal correlated program blocking table to determine a plurality of program rating codes used for screening television programs; and
displaying the plurality of program rating codes as highlighted rating codes in the correlated program blocking table to graphically illustrate to the user the program blocking effects of the personal correlated program blocking table.

14. The method as claimed in claim 1 further comprising:
provisioning the memory with a program content code table to permit users to further configure program viewing control of the television receiver by screening unblocked programs using program content codes; and
provisioning the television receiver with an interface that permits the user to selectively enable and disable program blocking based on any of the program content codes associated with the program content code table.

15. The method as claimed in claim 14 wherein provisioning the interface comprises displaying a table comprising a row with a column for each of the program content codes, each column containing a default blocking value associated with each program content code.

16. The method as claimed in claim 1 further comprising:
provisioning the memory with a program category code table to permit users to further configure program viewing control of the television receiver by allowing the display of selected unrated programs using program category codes; and
provisioning the television receiver with an interface that permits the user to selectively enable and disable unrated program blocking based on any of the program category codes associated with the program category code table.

17. The method as claimed in claim 16 wherein provisioning the interface comprises displaying a table comprising a row with a column for each of the program category codes, each column containing a default value associated with each program category.

18. A method for single-selection viewing control of a television receiver, comprising:
provisioning a memory of the television receiver with rating correlation data comprising rating codes associated with at least two rating systems used to rate television programs, the rating codes being arranged in predetermined correlated sets with an index associated with each of the correlated rating code sets; and
provisioning the television receiver with an interface that permits a user to input one of the indexes to configure the television receiver to screen television programs rated in accordance with any one of the at least two rating systems.

19. The method as claimed in claim 18 wherein provisioning the memory comprises any one of:
pre-configuring a read only memory of the television receiver with the rating correlation data;
downloading rating correlation data embedded in a television signal;
downloading rating correlation data embedded in a satellite direct broadcast signal;
downloading rating correlation data from a coaxial cable connection;
downloading rating correlation data in a broadband signal; and
downloading rating correlation data from a portable memory device.

20. The method as claimed in claim 19 wherein provisioning the television receiver with an interface comprises provisioning the television receiver to display a single-selection program blocking table comprising a first column containing an index and a second column containing a generic description of each correlated set of rating codes.

21. The method as claimed in claim 20 further comprising accepting an input of the index from the user, and translating the index using the correlated program blocking table to obtain a plurality of program rating codes to be used to screen television programs.

22. The method as claimed in claim 21 further comprising highlighting the plurality of program rating codes to be used to screen television programs in a correlated program blocking table, and displaying the highlighted correlated program blocking table to graphically illustrate to the user the effects of the index input.

23. The method as claimed in claim 20 wherein accepting the user input comprises accepting input of a single character to permit single-selection viewing control by the user.

24. The method as claimed in claim 18, further comprising providing a user interface to permit the user to construct a personal correlated program blocking table used to select rating codes for screening the television programs.

25. The method as claimed in claim 24 wherein providing the user interface comprises displaying a correlated program blocking table to the user, the correlated program blocking table having an associated row and column index to permit the user to specify rating codes to be placed in the personal correlated program blocking table.

26. The method as claimed in claim 25 wherein providing the user interface comprises:
providing a personal correlated program blocking table comprising a single row and a plurality of columns, one column for each of the at least two rating systems;
permitting the user to input an index for each column in the personal correlated program blocking table; and
translating the index into a rating code that is displayed in a corresponding column of the personal correlated program blocking table.

27. The method as claimed in claim 26 further comprising:
translating the personal correlated program blocking table to determine a plurality of program rating codes used for screening television programs; and
displaying the plurality of program rating codes as highlighted rating codes in the correlated program blocking table to graphically illustrate to the user the program blocking effects of the personal correlated program blocking table.

28. The method as claimed in claim 18 further comprising:
provisioning the memory with a program content code table to permit users to further configure program viewing control of the television receiver by screening unblocked programs using program content codes; and
provisioning the television receiver with an interface that permits the user to selectively enable and disable program blocking based on any of the program content codes associated with the program content code table.

29. The method as claimed in claim 28 wherein provisioning the interface comprises displaying a table comprising a row with a column for each of the program content codes, each column containing a default blocking value associated with each program content code.

30. The method as claimed in claim 18 further comprising:
provisioning the memory with a program category code table to permit users to further configure program viewing control of the television receiver by allowing the display of selected unrated programs using program category codes; and
provisioning the television receiver with an interface that permits the user to selectively enable and disable unrated program blocking based on any of the program category codes associated with the program category code table.

31. The method as claimed in claim 30 wherein provisioning the interface comprises displaying a table comprising a row with a column for each of the program category codes, each column containing a default value associated with each program category.

32. A television receiver, comprising:
computer readable memory for storing rating system correlation data comprising rating codes associated with at least two rating systems used to rate television programs, the rating codes being arranged in predetermined correlated sets; and
computer readable memory for storing computer program code for generating and displaying a single-selection program blocking table containing a plurality indexes and a generic program rating description associated with each index, each index being associated with one of the predetermined correlated sets of rating codes, the user interface permitting a user to input one of the indexes to configure the television receiver to screen television programs.

33. The television receiver as claimed in claim 32 further comprising computer readable memory for storing information associated with each rating system specifying how rating codes used by the rating system are embedded in television program signals.

34. The television receiver as claimed in claim 32 further comprising computer readable memory for storing a master control personal identification number that must be input before the one of the indexes can be input or changed.

35. The television receiver as claimed in claim 32 further comprising computer readable memory for storing a correlated program blocking table comprising one of a column and a row for each of the rating systems and the other of the column and the row for each of the correlated sets of rating codes.

36. The television receiver as claimed in claim 32 further comprising computer readable memory for storing user preference information computed by a processor executing computer program code that accepts the user input of the one of the indexes.

37. The television receiver as claimed in claim 36 further comprising computer executable program instructions executed by the processor to translate the one of the indexes into a plurality of rating codes used for screening television programs.

38. The television receiver as claimed in claim 36 further comprising computer readable memory for storing a plurality of personal identification numbers, each personal identification number being associated with user preference information.

39. The television receiver as claimed in claim 32 further comprising computer readable memory for storing a program content code table to permit the user to further configure the television receiver to screen the television programs based on program content codes associated with the television programs.

40. The television receiver as claimed in claim 32 further comprising computer readable memory for storing a program category code table to permit the user to further configure the television receiver to selectively allow unrated programs to be viewed based on program category codes associated with the television programs.

41. A computer readable modulated signal comprising rating correlation data used to permit a user to configure a television receiver to screen television programs by entering an index associated with a generic description of a correlated set of rating codes respectively associated with at least two different television program rating systems used to rate television programs in a geographical area in which the television receiver is used.

42. The computer readable modulated signal as claimed in claim 41 wherein the correlation data comprises:
data for filling or modifying a single-selection correlation table comprising an index and a generic description of each of a plurality of program blocking levels that can be used to screen television programs in a given geographic region; and
data for filling or modifying a correlated program blocking table comprising one of a column and a row for each of a plurality of rating systems used in the geographic region and the other of a column and a row for each of a plurality of correlated rating code sets associated with respective ones of the program blocking levels.

43. The computer readable modulated signal as claimed in claim 41 wherein the correlation data further comprises data for filling or modifying a program content code table to permit users to further configure program viewing control of the television receiver by screening unblocked programs using program content codes embedded in a television program broadcast signal.

44. The computer readable modulated signal as claimed in claim 41 wherein the correlation data further comprises data for filling or modifying a program category code table to permit users to further configure program viewing control of the television receiver by allowing the display of selected unrated programs using program category codes embedded in a television program broadcast signal.

45. The computer readable modulated signal as claimed in claim 41 wherein the computer readable modulated signal comprises any one of:
rating system correlation data embedded in a television signal;
rating system correlation data embedded in a satellite direct broadcast signal;
rating system correlation data received via a coaxial cable connection;
rating system correlation data received in a broadband signal; and
rating system correlation data received from a portable memory device.

46. A computer readable modulated signal comprising rating system correlation data used to permit a user to configure a television receiver to screen television programs by entering an index to identify a correlated set of rating codes respectively associated with at least two different rating systems used to rate television programs in a geographical area in which the television receiver is used.

47. The computer readable modulated signal as claimed in claim 46 wherein the rating system correlation data comprises data for filling or updating a single-selection program blocking table comprising a plurality of indexes and a corresponding plurality of generic descriptions of program blocking levels that can be selected by the user.

48. The computer readable modulated data signal as claimed in claim 47 further comprising data for filling or updating a correlated program blocking table used to store correlated sets of rating codes.

49. The computer readable modulated data signal as claimed in claim 47 further comprising data for filling or updating at least one of a program content code table and a program category code table.

50. The computer readable modulated signal as claimed in claim 46 wherein the signal comprises any one of:
rating system correlation data embedded in a television signal;
rating system correlation data embedded in a satellite direct broadcast signal;
rating system correlation data received via a coaxial cable connection;
rating system correlation data received in a broadband signal; and
rating system correlation data received from a portable memory device.
